(19) United States
(12) Patent Application Publication
(10) Pub. No.: US 2014/0236683 A1
(43) Pub. Date: Aug. 21, 2014

(54) INTERACTIVE ADVERTISING METHODS AND SYSTEMS

(71) Applicant: Eunum, LLC, Roseville, MN (US)

(72) Inventors: William Howe, Chicago, IL (US); George Aris Michalopoulos, Chicago, IL (US)

(73) Assignee: Eunum, LLC, Roseville, MN (US)

(21) Appl. No.: 14/183,279

(22) Filed: Feb. 18, 2014

Related U.S. Application Data
(60) Provisional application No. 61/765,806, filed on Feb. 18, 2013.

(51) Int. Cl. G06Q 30/02

(52) U.S. Cl. CPC G06Q 30/0257
USPC 705/12

(57) ABSTRACT

Systems and methods allow consumers of advertisements to vote on advertisements in order to receive an offer, discount, etc. from the advertisers. After advertisers are selected, consumers vote on offers that advertisers have extended to the consumer if they vote for the advertisement and/or if their advertisement is selected as a winner. After a period of time, or any other trigger, one or more winning advertisements may be selected and the winning advertisers must honor their offers/prizes to a selected subset of consumers. The selected subset may be all consumers, all consumers who voted for the winning advertisement, all consumers having defined demographic or behavioral information, etc.

This application claims priority to U.S. provisional patent application No. 61/765,806, filed Feb. 18, 2013, which is hereby incorporated by reference in its entirety.

### TECHNICAL FIELD

This disclosure relates generally to systems and methods related to advertising. Specifically, this disclosure relates to advertising in which consumers of advertisements may interact with the advertisements and vote on them.

### BACKGROUND

Advertisers may use advertisements to reach large audiences on the Internet, on television and in other forms of media. Many websites on the Internet regularly display advertisements such as banner advertising, text advertising, multimedia advertising, etc.

To reach a more responsive audience, advertisers present different contextual advertisements to different consumers, such as keyword ads or advertisements displayed based on consumers' profiles. For example, in a keyword advertising scheme an advertiser pays to display an advertisement to a consumer in response to the consumer performing a key-word search on a search engine. In other schemes, advertisements may be displayed to a consumer based on the consumer's profile to present advertisements that are compelling to the consumer's demographic. However, consumers are predominately passive when viewing pre-selected advertisements, whether the advertisements are preselected based on keywords or the consumers' profiles.

Traditional advertisements are ineffective or otherwise less desirable because the consumer is not a participant in the advertisements and become jaded to advertisements and subconsciously ignore them. Accordingly, needs exists for improved advertisements based on consumers' interactions with the advertisements.

### SUMMARY

Embodiments disclosed herein provide systems and methods for advertising in which viewers or consumers of advertisements (referred to hereinafter as “consumers”) vote on advertisements in order to receive some benefit, such as an offer, discount, prize, etc. (hereinafter referred to as an “offer”), from the advertisers.

Advertisers may pay to display their advertisements on a channel. The term channel used herein may refer to any form of media or other outlet allowing advertisers to extend offers via advertisements. Example channels include television channels, radio stations, websites and domains, the Internet, emails and newsletters, etc. A channel may select advertisers to be paid sponsors by auction, first-come first-served at a given price, or any another desired selective or editorial process. Each advertisement may be associated with an offer from the advertiser. The advertisements may be any form of communication or media to encourage consumers to perform some action, such to purchase a product or service via an offer extended in the advertisement, or to develop brand identity or awareness.

After advertisements are selected to be displayed on the channel, consumers may vote on offers an advertiser has extended in association with its advertisement(s). The offers serve as benefits the consumer may receive, either just for voting for that offer or if the offer the consumer votes for is selected as a winning offer. In some embodiments, the offers may be the advertisements. Where the offer is sufficiently connected to an advertisement, e.g. it is the advertisement or is within or a part of the advertisement, a vote for an offer may be considered a vote for an advertisement, and vice versa. In other embodiments, consumers may vote on offers they do not wish to receive, and the winner(s) may be selected based on the advertisement(s) with the fewest such votes.

Any type of voting may be utilized, including one vote per consumer or weighted voting where some consumers may get more votes than others. For example, a channel may be a website and consumers may be members of the website. Members of the website may gain points based on activities on the website, or otherwise, and the number of votes allocated to a member may be based on the member's points. The number of votes allocated may be related to the number of member points in any known fashion, for example the number of votes may be a rounded square root or cube root of the number of points, such that at higher point levels more points are required to obtain an additional vote. Some members may receive no votes at all, for example based on having a low number of points. Voting may be “choose one”, approve/disapprove, or “choose n” where n is any chosen integer. Consumers with multiple votes may be able to spread those votes among different offers. A voting process may include one or more run-off votes to determine ultimate winners, or any other known voting procedure.

After a given period of time has elapsed, or upon any other triggering event, such as reaching a threshold number and/or percentage of votes for any single offer or for all the offers combined, a winning offer may be determined and the advertiser must honor its offer to a preselected subset of consumers. The denominator for determining a percentage of votes may be based on the number of possible viewers of a channel, the number of active users of a channel, the number of members of a channel having voting rights, etc. For example, for an Internet website, the denominator could be the number of registered members of the website, the number of daily visitors, number of weekly or monthly visitors, the number of registered members having voting rights, etc. Voting may then end when some percentage of this number of votes has been collected—e.g. 5% of total registered members, 10% of monthly active visitors, etc. As fine-grained an approach as desired may be used (e.g., voting may end when a certain percentage of website members with voting rights, who have been members for a year or more, and who recently purchased a retail item through a link on the website, have voted). Viewership information may similarly be obtained for channels in other media, such as TV channels (for example using Nielsen ratings).

In embodiments, the advertiser with the winning offer may receive advertising credits, cash, or other incentives via the channel or from an entity controlling the medium (e.g. channel) through which the associated advertisement was presented, or from an entity that the advertiser is an affiliate of.

A new computer-implemented method of interactive advertising implemented in a computer network that includes one or more processors executing one or more modules includes receiving advertisements from advertisers, the advertisements including offers to be extended to consumers, transmitting the advertisements, the advertisements being configured to be presented to the consumers, receiving one or more votes associated with one or more of the advertisements from the consumers during a voting period, triggering an end of the voting period, determining numbers of votes received for the advertisements during the voting period, determining a winning advertisement, and extending the offer included with the winning advertisement to a selected subset of the consumers. Extending the offer may involve giving the consumer the opportunity to receive the offer, for example by sending a link to accept the offer in an email, or automatically transmitting the offer to the consumer. For example, a customer's payment information may already be known and may be charged to pay for an offer when it is determined to extend that offer to the customer.

The method may also include grouping the received advertisements according to at least one of subject matter, target demographic, and interested demographic, and transmitting the advertisements in groups. One or more winner may be determined for each group. One or more of the groups of advertisements may be transmitted accompanying content pertaining to the subject matter of the groups or being of interest to the target demographic of the groups or demographic interested in the groups.

The method may also include receiving location information about the consumers, where the advertisements are transmitted to consumers based on the received location information.

The triggering may be associated with a defined time period elapsing, an advertisement threshold associated with the number of votes received by the advertisement being crossed, or a vote threshold associated with a total number of votes received being crossed.

The method may also include receiving information about the consumers, where the information includes demographic information or behavioral information. The selected subset may be associated with at least one of the demographic information and the behavioral information. Multiple winning advertisements maybe determined, one or more of the winning advertisements being demographic winners chosen on the basis of receiving the most votes from consumers sharing certain demographic information. The selected subset of each of the demographic winners may correspond to the demographic information of the consumers from which the demographic winner received the most votes.

The selected subset may include consumers who voted for the advertisement.

An advertiser associated with the winning advertisement may receive one or more incentives from a channel that presented the winning advertisement to the consumers. The incentive may be received directly through the channel or for example from a company that controls and/or owns the channel.

The triggering may be associated with votes cast reaching a threshold percentage of total possible votes or a threshold percentage of a portion of total possible votes representing a number of votes reasonably likely to be cast.

A new interactive advertising system includes one or more computing devices configured to execute modules. The modules include a receiving module configured to receive advertisements from advertisers, the advertisements including offers to be extended to consumers, a communication module configured to transmit the advertisements, the advertisements being configured to be presented to the consumers, a voting module configured to receive votes associated with the advertisements during a voting period and to determine numbers of votes received for the advertisements during the voting period, a trigger module configured to trigger an end of the voting period, a winner selection module configured to determine a winning advertisement, and an offer module configured to extend the offer included with the winning advertisement to a selected subset of the consumers. The receiving module may receive the advertisements directly from the advertisers electronically, or indirectly and/or non-electronically. For example, the advertiser may call in the details of the advertisement and these details may be entered manually into the receiving module.

The system may also include a grouping module configured to group the received advertisements according to at least one of subject matter, target demographic, and interested demographic, and the transmitting module may be configured to transmit the advertisements in groups. The winner selection module may be configured to determine one or more winner for each group. The communication module may be configured to transmit one or more of the groups of advertisements accompanying content pertaining to the subject matter of the groups or being of interest to the target demographic of the groups or demographic interested in the groups.

The communication module may be further configured to receive information about the consumers, where the information includes demographic information or behavioral information. The winner selection module may be configured to determine multiple winning advertisements, one or more of the winning advertisements being demographic winners chosen on the basis of receiving the most votes from consumers sharing certain demographic information. The selected subset of each of the demographic winners may correspond to the demographic information of the consumers from which the demographic winner received the most votes.

The system may also include an incentive module configured to provide at least one incentive to an advertiser associated with the winning advertisement.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 depicts an embodiment of network topology for an advertising network.

FIG. 2 depicts an embodiment of a method for selecting a winning advertisement.

FIG. 3 depicts an embodiment of a method for receiving an offer associated with a winning advertisement.

FIG. 4 illustrates a system configured to provide interactive advertising, in an embodiment.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk (HD)), hardware circuitry or the like, or any combination.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment.”

Embodiments of the present invention can be implemented in a computer communicatively coupled to a network (for example, the Internet, an intranet, an internet, a WAN, a LAN, a SAN, etc.), another computer, or in a standalone computer. As is known to those skilled in the art, the computer can include a central processing unit (“CPU”) or processor, at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, etc.), or the like. In embodiments of the invention, the computer has access to at least one database over the network.

ROM, RAM, and HD are computer memories for storing computer-executable instructions executable by the CPU or capable of being complied or interpreted to be executable by the CPU. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a DASD array, magnetic tape, floppy diskette, optical storage device, or other appropriate computer-readable medium or storage device.

In one exemplary embodiment of the invention, the computer-executable instructions may be lines of C++, Java, JavaScript, HTML, Python, or any other programming or scripting code. Other software/hardware/network architectures may be used. For example, the functions of the present invention may be implemented on one computer or shared among two or more computers. In one embodiment, the functions of the present invention may be distributed in the network. Communications between computers implementing embodiments of the invention can be accomplished using any electronic, optical, radio frequency signals, or other suitable methods and tools of communication in compliance with known network protocols.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

It will be understood for purposes of this disclosure that a module is one or more computer processes, computing devices or both, configured to perform one or more functions. A module may present one or more interfaces which can be utilized to access these functions. Such interfaces include APIs, web services interfaces presented for a web services, remote procedure calls, remote method invocation, etc. While embodiments are described having certain modules carrying out certain functions, in other embodiments the functions of the various disclosed modules may be arranged differently, in other words some or all of the functions of one disclosed module may be carried out instead by another disclosed module, or by an additional module, and/or one or more modules may be eliminated or incorporated into another module.

Embodiments as disclosed below relate to systems and methods for advertising on a channel. In embodiments, advertisers may create interactive advertisements where consumers' votes for offers presented via the advertisements affect what offers are extended to the consumers. Advertisements may engage consumers to illicit responses from consumers to promote their brands or otherwise advertise products and/or services in virtual and real environments, such as computer networks and other interactive media including interactive televisions, smart phones, tablets, etc. Embodiments allow consumers to interact with advertisements and vote upon which offers, presented in association with the advertisements, they desire to receive. In an embodiment, after a trigger, such as a period of time elapsing or an offer reaching a vote threshold, the advertiser must honor its offer to a determined set of consumers.

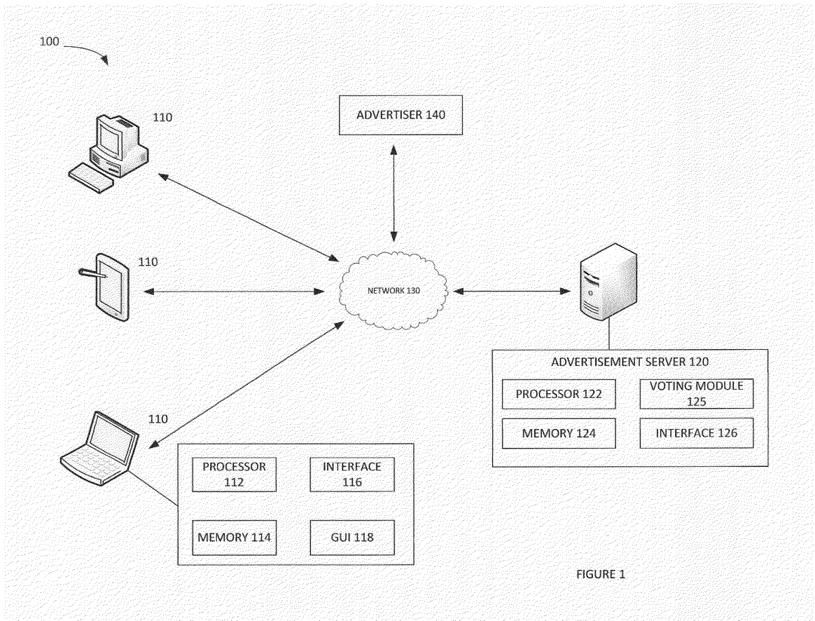

FIG. 1 depicts one embodiment of network topology 100 for an advertising network. The topology 100 includes one or more client devices 110 and advertisers connected to an advertising server 120 over a network 130.

The network 130 may be a wired or wireless network such as the Internet, an intranet, a LAN, a WAN, a cellular network or another type of network. It will be understood that network 130 may be a combination of multiple different kinds of wired or wireless networks.

Client device 110 may be a smart phone, tablet computer, laptop computer, desktop computer, smart television, personal data assistants or any other type of device with a processor to process instructions and connect to network 130, one or more portions of network 130, and/or advertisement server 120. Client device 110 may have hardware components such as a processor 112, memory 114, communication interface 116 and graphical user interface (GUI) 118.

Processor 112 can include memory, e.g., read only memory (ROM) and random access memory (RAM), storing processor-executable instructions and one or more processors that execute the processor-executable instructions. In embodiments where processor 112 includes two or more processors, the processors can operate in a parallel or distributed manner. Processor 112 can execute the operating system, browser, and/or any other applications of client device 110. Memory 114 is a device that stores data generated or received by client device 110. Memory 114 can include, but is not limited to, a hard disc drive, an optical disc drive, and/or a flash memory drive. Communication interface 116 is a device that allows client device 110 to communicate with another device, e.g., advertising server 120 via network 130. Communication interface 116 can include one or more wireless transceivers for performing wireless communication and/or one or more communication ports for performing wired communication. GUI 118 may be an interface configured to present an advertisement to and allow a consumer operating client device 110 to interact with data and/or graphics on a display of client device 110. GUI 118 may include a plurality of input objects that input commands on client device 110. In one embodiment, advertisements may be presented on GUI 118, and the consumer can vote on offers they would like to receive that are extended in the advertisements via GUI 118.

Advertisers 140 may be any company, organization, group, institution, etc. desiring to make offers regarding products, services and/or messages via advertisements to consumers or potential consumers. Thus, the advertisement offers may relate to products or services, or may simply be attached to a message such as for brand awareness or a public service announcement (e.g. “Don't do drugs”). By way of example, an offer relating to a message might be that a consumer gets a 10% discount on a product or a free wristband if they sign a pledge not to do drugs. The advertisements may be presented in any form of media such as audio, picture-based, text-based, streaming video, other multimedia modalities, etc. Advertisers 140 may transmit the advertisement to advertisement server 120 to be presented to a consumer operating client device 110 over network 130.

Advertisement server 120 may be a computing device such as a general platform server that is capable of supporting interactions between advertisers 140 and client device 110. Advertisement server 120 may include physical computing devices residing at a particular location or may be deployed in a cloud computing network environment. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Advertisement server 120 may include any combination of one or more computer-usable or computer-readable media. For example, advertisement server 120 may include a computer-readable medium that includes one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations may be written in any combination of one or more programming languages. Advertisement server 120 may include any combination of one or more computer-usable or computer-readable media.

Advertising server 120 may be a part of or linked with a website server, or may be independent therefrom and transmit its advertisements over network 130 to various websites and/or other channels. In one embodiment, advertisement server 120 may include hardwired devices such as a processor 122, memory 124, voting module 125, and interface 126.

Processor 122 may include memory, e.g., read only memory (ROM) and random access memory (RAM), storing processor-executable instructions, and one or more processors that execute the processor-executable instructions. In embodiments where processor 122 includes two or more processors, the processors can operate in a parallel or distributed manner. In the illustrative embodiment, processor 122 may execute and support operations associated with voting module 125.

Memory 124 may be a device that stores data generated or received by advertising server 120 and/or client device 110. Memory 124 can include, but is not limited to, a hard disc drive, an optical disc drive, and/or a flash memory drive. Further, memory 124 may be distributed and located at multiple locations, and is accessible to processor 122.

Interface 126 is a device that allows advertisement server 120 to communicate with other elements, e.g., the client device 110 and/or advertisers 140, via network 130. Interface 126 can include one or more wireless transceivers for performing wireless communication and/or one or more communication ports for performing wired communication.

Voting module 125 may be configured to execute a selection process associated with advertisements stored in memory 124 received from advertisers 140 and/or client device 110. In one embodiment, voting module 125 may receive advertisements from advertisers 140 that pay to present their advertisements to client device 110. Advertisers may pay in at least the following ways: lump sum, commissions for sales, pay-per-vote, pay per non-vote, pay-per-click, pay-per-impression, percentage of offer extended in advertisements, or any other payment scheme associated with the advertisement presented on client device 110. In other embodiments, voting module 125 may receive advertisements from advertisers 140 using any known selection process, such as receiving advertisements from advertisers 140 that are associated with a category of products/services, advertisers 140 that direct advertisements towards a certain demographic group, etc. Voting module 125 may also group advertisements within memory 124. Advertisements within a group may be voted upon by the consumer operating client device 110 to determine one or more winning advertisements within the group.

The advertisements may be grouped based on any known mechanism, which may or may not be based on empirical data associated with demographic groups or other subsets of consumers and/or known consumer behavior. Advertisements may be grouped based on the demographics of the channels over which they are distributed, the amount of money paid by the advertisers to distribute them, the subject matter of the advertisements, and the like. For example, received advertisements may be grouped based on associations with contents on various pages of a website (or analogously, various programs of a TV channel or radio station). Thus, a sports website might group together advertisements associated with tennis and place them on a website page having tennis-related subject matter, and group together advertisements associated with basketball and place them on another website page having basketball-related subject matter. The association with subject matter may not be explicit—rather, for example, advertisements may be placed in the tennis group based on being of interest to a demographic of consumer also having an interest in tennis, or on being of interest to a set of consumers whose known behavior (website visited, activity on various webpages) indicates an interest in tennis. In another example of the association with subject matter not being explicit, advertisements may be placed in the tennis group based on the advertisers wanting to connect with consumers of a demographic having an interest in tennis (i.e., BMW advertising in the tennis group due to higher than average incomes in the tennis-viewing demographic). In some embodiments, advertisers who pay more may have their advertisements be grouped together on a program, website, etc. with higher viewership. In some embodiments, advertisement server 120 may choose from various channels through which to display advertisements, and advertisements may be grouped based on association with channel subject matter similarly to the description above with respect to webpage subject matter.

Upon receiving an advertisement from advertiser 140, voting module 125 may store the advertisement in memory 124. The advertisement may be stored in memory 124 along with an identifier identifying a name associated with advertiser 140. Voting module 125 may communicate data associated with the advertisements stored within memory 124 configured to be presented on client device 110. In some embodiments, voting module 125 or another module determines which channels to distribute the advertisements over and/or the parameters of the distribution (location, time/frequency, etc.), for example based on the subject matter of the advertisements, the demographics of the channels, the locations of users viewing/receiving the channels, the amount of money paid by the advertisers to distribute them and/or charged by the channels to carry them, and/or the nature of the advertisement (text, multimedia, etc.), etc.

For example, advertisements may be distributed based on advertiser location(s) and on consumer locations. Thus, advertisements may be distributed to consumers who are physically near a location of the corresponding advertisers. This may be accomplished by distributing such advertisements through localized channels, such as radio stations, newspapers, etc., and/or by distributing the advertisements on the basis of location within channels. In some embodiments, advertising server 120 may be dedicated to a single channel or group of channels and may not have much if any ability to select between channels. However, localization can still be achieved by detecting locations of individual users as described in more detail below. A website channel can ordinarily determine the location of viewers by IP address and/or GPS (for viewers on mobile devices) and different advertisements can be displayed to different viewers on the channel based on location. Other channels may determine the locations of consumers using various known mechanisms.

In some embodiments, a group of advertisements distributed to a consumer may correspond to similar products and/or services offered near the consumer's location. For example, all the ads in the group might be for restaurants, or specifically for fast food restaurants. In such embodiments, the consumer may vote on an advertisement from the group and immediately obtain the offer associated with that ad (i.e., not based on votes of others). The data collected in that way constitutes survey data which may be analyzed and used for various purposes, for example to determine consumer preferences between different product/service providers and the effectiveness of various ads under various conditions (e.g. for consumers having certain characteristics, in certain locations, for certain products/services, etc.). Making the product/service offered similar helps in determining why an ad was chosen by eliminating the influence of immediate need. For example, a consumer may be hungry and looking to eat, causing the consumer to prefer ads for restaurants without regard to the quality of an ad or associated offer. Making all the advertisements in the group restaurant ads eliminates that factor. The type of products/services advertised may be based on any known data about the consumer, which may include for example website browsing information that provides some indication of the consumer's present intentions.

In other embodiments, the ads in the group are not all associated with similar products/services. In such embodiments, the ad chosen by the consumer may aid in determining what consumer data (e.g. demographics, location, browsing history, device, etc.) predicts/indicates consumers' present preferences. For example, if consumers in a certain area frequently select restaurant ads when in a certain location, that location may be determined to be a reliable predictor of an interest in restaurant services. Similarly, that location may be determined to be a reliable indicator of restaurant interest for certain age groups and not for others, etc.

Client device 110 may receive the data associated with the advertisement and present the advertisement via GUI 118. The advertisements may be displayed all together or in groups, and may be displayed in banner ads or as sections of a single banner ad, on special web pages, in advertising sections or blocks within websites or photoplays, in page pop-ups, windows, app screens, etc. The advertisements may be presented in any known form of media compatible with the channel through which they are distributed, such as audio, visual, text, movie, flash, within a banner, text-message, smart phone app, email, etc. The advertisement may include a potential offer that is extended to consumers if the consumer operating client device 110 votes for the offer and/or if the offer is selected as a winner. In embodiments and as desired, users may receive offers despite not voting for the winning advertisement. Utilizing an input mechanism on GUI 118, the consumer may vote on an offer extended in the advertisement that they wish to receive. In other embodiments, consumers may vote on offers in advertisements they do not wish to receive.

In response to a consumer voting on an offer on GUI 118, client device 110 may transmit data associated with the offer that the consumer voted on, characteristics associated with the consumer, a client device 110 identifier, and data indicating that the consumer voted upon the offer to voting module 125. The characteristics associated with the consumer may include an email address, address of the consumer, phone number, or any other contact information for the consumer, demographic information and/or behavioral information. Demographic information may include, but is not limited to, the type of media channel that the advertisement was presented on and/or an age, location, job, income and/or gender, etc. associated with the consumer. Behavioral information may include information relating to actions the consumer has taken, for example online this information may include the amount of time they have spent on various websites, the specific pages they viewed and the time spent on each page, the subject matter of the content they viewed, links they clicked and items they purchased, etc.

Voting module 125 may receive the transmitted data from client device 110 and store the data within memory 124. The data stored may include the contact information of the consumer, the demographic information for the consumer, behavioral information for the consumer, and/or an identifier associated with the offer that the consumer voted for. In one embodiment, voting module 125 may increment a tally associated with the offer and store a time stamp identifying the data and time that the data was received by voting module 125 from client device 110.

After a trigger, such as a time period elapsing, total number or percentage of votes cast surpassing a threshold, and/or an offer receiving a number of votes greater than a threshold, vote module 125 may end the voting period and determine one or more winning offers. In embodiments, the time period may be set by the advertising server 120 or advertiser 140 or by a channel, and may be global to all channels or unique to a given channel or group of channels. In some embodiments, after a group of offers/advertisements is formed by voting module 125, a time period for the trigger, such as a week, is set for the group by the advertising server. The time period set may be based on the number of consumers viewing a given channel. So a popular website may have a shorter time period since more votes will be received and a most popular offer for users of that channel can be determined rapidly. If time periods are associated with individual offers or groups of offers, memory 124 may store timestamps for when each offer became available for viewing or entered the database.

The winning offer(s) may be determined based on the offer(s) with the most number of votes, most number of clicks, the fewest number of votes, or any other interactive selection criteria. Any selection criteria based on an interaction between consumers and advertisements may be used. In embodiments, multiple winning offers may be selected (e.g. two of five offers might win, or the top three, top N, etc.), and offers may be selected as winners for different demographics (e.g. one winner for women and one for men, etc.). The different demographics may be associated with consumers who voted for the offers, and/or winning offers may be based on the channel that the offer was presented in (e.g. a certain number of winners per website or other channel).

In response to a winning offer being determined, the advertiser associated with the winning offer may or must honor their offer extended in the advertisement to a selected subset of consumers. Here, the term consumer is defined loosely to mean any person or entity which may be interested in the product, service, information, etc. offered by an advertiser. The selected subset of consumers may be for example all consumers, consumers who viewed the associated advertisement, consumers who voted on the offer, the first n consumers who voted on the offer or the first n customers to attempt to redeem the offer, consumers who did not vote for the offer, consumers who viewed the advertisement on a specific channel, consumers who are members or subscribers of the channel or a subset of members or subscribers such as the most active or those who joined earliest, and/or those who voted or voted for the winning offer, consumers in a specific demographic (e.g. men, women), any combination of the above, etc. In some embodiments, the selected subset of consumers may be determined at the advertisement server, and in other embodiments by an advertiser or by a channel where the advertising appears.

Voting module 125 may notify consumers within the selected subset of the winning offer via the contact information stored within memory 124 and send the offer extended. Alternatively, the advertiser may be responsible for sending offers directly to the consumers. The advertisement server may maintain a list of consumers eligible to receive offers and forward that information to advertisers for that purpose, or such information may be transmitted directly to advertisers when votes are cast. In further embodiments, the winning advertiser may receive advertising credits, cash, or other incentives from a channel that presented the offer, or from an entity the advertiser is an affiliate for. Furthermore, the advertisement and/or advertiser associated with the winning offer may receive additional exposure after winning the vote. For example, the winning advertisement may continue to be shown for some time after winning, or a related advertisement may be shown, which may stress the winning offer, and may be displayed in a prominent location, timeslot, etc. Furthermore, the winning offer, or some variation of the winning offer (that for example may be less desirable), may in embodiments continue to be available after the vote is over, even to consumers who did not participate in the vote.

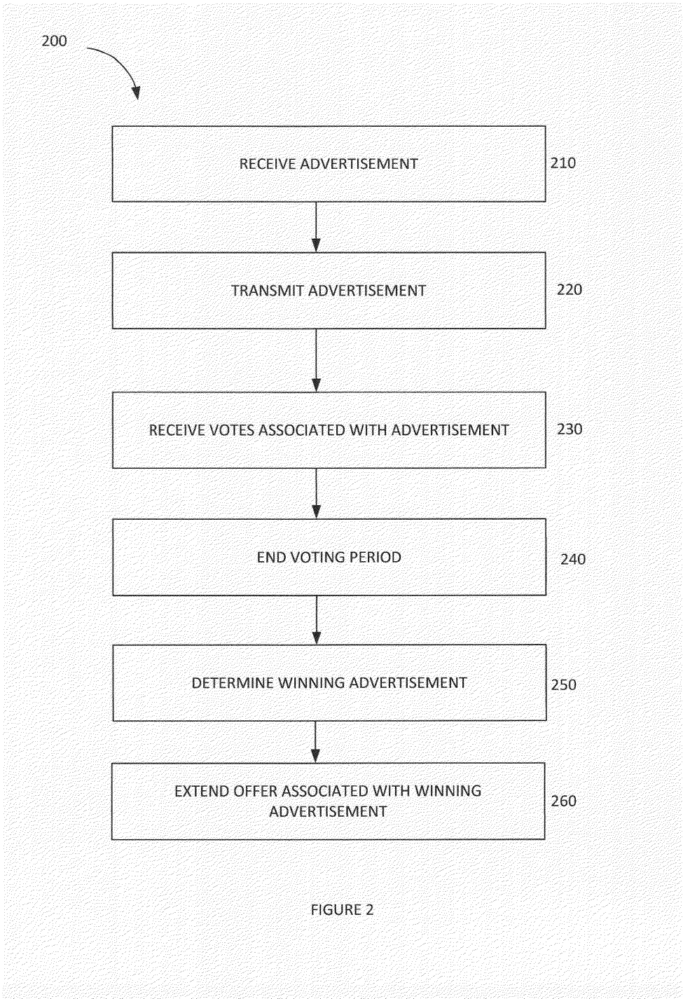

FIG. 2 depicts an embodiment of a method 200 for selecting a winning advertisement. One skilled in the art will appreciate that the following method is presented as an exemplary non-limiting embodiment, where in other embodiments steps may be performed in various orders, combined, omitted, and/or additional steps may be included.

In some embodiments, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At step 210, an advertisement including an offer to be extended to consumers may be received. The advertisement may be associated with a product and/or service, and may be configured to be presented in any form of media such as audio, picture-based, text-based, text-message, email, phone call, streaming video, other multimedia modalities, etc. to consumers. Step 210 may be performed by a receiving module that is the same as or similar to receiving module 408, in accordance with one or more implementations.

At step 220, the advertisement may be transmitted to client devices to be presented to consumers via any known channel and/or a plurality of channels. Different types of channels include the Internet, television, radio, etc. Advertisements may be transmitted to consumers based on received location information. The received advertisements may be grouped according to at least one of subject matter, target demographic, and interested demographic, and transmitted in groups. One or more of the groups of advertisements may be transmitted accompanying content pertaining to the subject matter of the groups and/or being of interest to the target demographic of the groups and/or demographic interested in the groups. Step 220 may be performed by a grouping module and/or a communication module that are the same as or similar to grouping module 420 and/or communication module 410, in accordance with one or more implementations.

At step 230, data associated with votes for the offers may be received from client devices. The data may include an indication if a consumer voted for an advertisement, an identifier of the advertisement, contact information associated with the voting consumer, demographic information, behavioral information, and/or location information associated with the voting consumer. Further, at step 230, a number of votes associated with an advertisement may be incremented if the received data indicates that the consumer voted for the advertisement. In embodiments, the data may also be used for other purposes. The data constitutes implicit survey data and may be useful to many companies in addition to the advertisers. For example, the data may be very useful to advertising agencies and large companies for tailoring advertisements to different consumers and groups of consumers. Thus, the data may be retained, analyzed and/or redistributed for various purposes. Step 230 may be performed by a voting module that is the same as or similar to voting module 412, in accordance with one or more implementations.

At step 240, a trigger may determine the end of a voting period. The trigger may be associated with a time period elapsing, a total number of tallied votes or percentage of possible or likely votes cast being greater than a vote threshold, and/or an advertisement receiving a number of votes greater than an offer threshold. The trigger may be associated with votes cast reaching a threshold percentage of total possible votes or a threshold percentage of a portion of total possible votes representing a number of votes reasonably likely to be cast. In other embodiments, any known trigger mechanism may be used to determine the end of a voting period. Step 240 may be performed by a trigger module that is the same as or similar to trigger module 414, in accordance with one or more implementations.

At step 250, a winning advertisement may be determined. The winning advertisement may be determined based on the advertisement with the most votes, the fewest number of votes, or any other selection criteria. In embodiments, multiple winning advertisements may be selected and/or advertisements may be selected as winners for different demographics. In embodiments, different demographics may be associated with consumers who voted in the advertisements, and winning advertisement may be based on consumer demographics and/or the channel that the advertisement was presented in. Where advertisements are transmitted in groups, one or more winners may be selected for each group. One or more of the winning advertisements may be demographic winners chosen on the basis of receiving the most votes from consumers sharing certain demographic information. The selected subset of each of the demographic winners may corresponds to demographic information of the consumers from which the demographic winner received the most votes. An advertiser associated with a winning advertisement may receive at least one incentive from a channel that presented the winning advertisement to the consumers. Step 250 may be performed by an incentive module and/or a winner selection module that are the same as or similar to incentive module 422 and/or winner selection module 416, in accordance with one or more implementations.

At step 260, advertisers associated with a winning advertisement may honor the offer extended in the advertisement to at least a selected subset of consumers. The selected subset may include consumers who voted for the advertisement. Consumers within the selected subset may be notified of the offer extended in a winning advertisement via contact information associated with the consumer received at step 230. The selected subset may be associated with at least one of demographic information and behavioral information regarding the consumers. In implementations, the advertisements may relate to products and/or services near the consumers, and the consumers may be immediately given the offers included in the advertisements they vote for regardless of whether the advertisement wins a vote. Step 260 may be performed by an offer module that is the same as or similar to offer module 418, in accordance with one or more implementations.

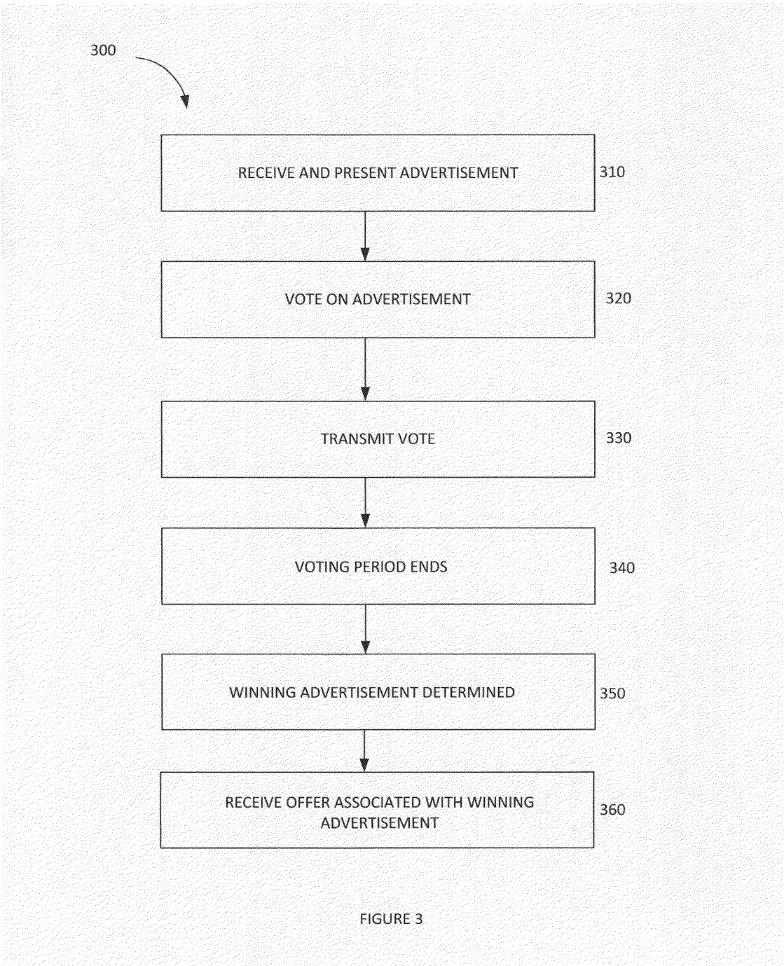

FIG. 3 depicts an embodiment of method 300 for receiving an offer associated with a winning advertisement. One skilled in the art will appreciate that the following method is presented as an exemplary non-limiting embodiment, where in other embodiments steps may be performed in various orders, combined, omitted, and/or additional steps may be included.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At step 310, an advertisement associated with an offer for a product and/or service may be received and presented to a consumer. The advertisement may be received via any known channel or any known form of media including a website, television, radio, radio, etc.

At step 320, a consumer may vote for whether they would like to receive or not receive the offer extended in the advertisement. The consumer may vote on the advertisement by performing an action on a graphical user interface of the client device that presented the advertisement to the consumer, or may vote by text-message, phone call, or any other known communication method. The contact information for the text message, phone call, etc. may be displayed with the advertisement.

At step 330, data associated with the consumer's vote may be transmitted. The data may include an indication identifying whether or not the consumer voted for an advertisement, contact information for the consumer, demographic and/or behavioral information associated with the consumer.

At step 340, a trigger may end a voting period. The trigger may be associated with a time period elapsing, a total number of tallied votes being greater than a vote threshold, and/or an advertisement receiving a number of votes greater than an advertisement threshold. In other embodiments, any known trigger mechanism may be used to determine the end of a voting period.

At step 350, a winning advertisement may be determined and advertisers associated with a winning advertisement may honor the offer extended in the advertisement to a selected subset of consumers. The winning advertisement may be determined based on the advertisement with the greatest number of votes, the fewest number of votes, or any other selection criteria. In embodiments, multiple winning advertisements may be selected and advertisements may be selected winners for different demographics. In embodiments, different demographics may be associated with consumers who voted in the advertisements, and winning advertisements may be based on consumer demographics or the channel that the advertisement was presented in.

At step 360, consumers within the selected subset may receive the offer extended in a winning advertisement via the contact information associated with the consumer received at step 330.

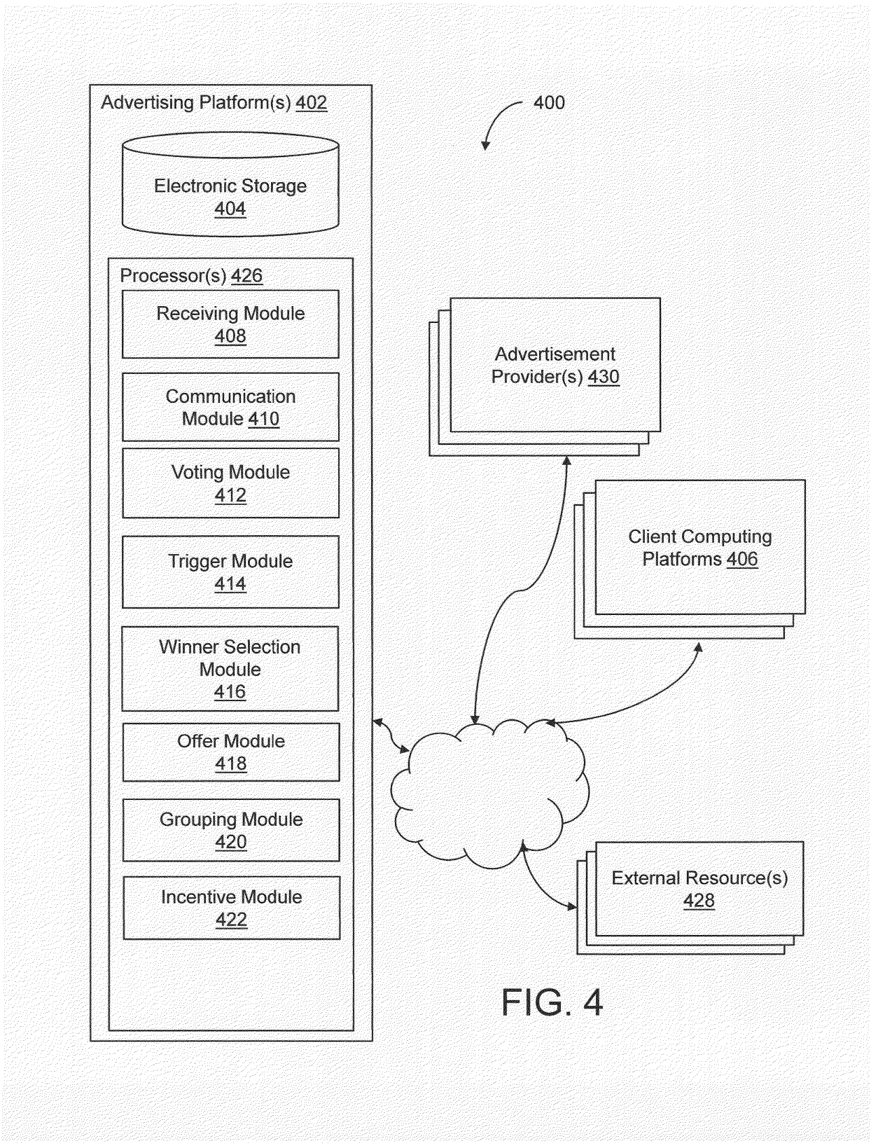

FIG. 4 illustrates a system 400 configured to provide interactive advertising to users, in an embodiment. Providing the interactive advertising may include hosting an advertising platform over a network. Advertising platform 402 may be configured to communicate with one or more client computing platforms 406 according to a client/server architecture. Users may access system 400 via client computing platforms 406. Advertising platform 402 may be a stand-alone system or a part of a larger system such as a website or other channel through which advertisements may be displayed to users. The advertising platform 402 may receive advertisements from advertisement providers 430, which may be for example the systems of individual advertisers, which submit their ads directly to advertising platform 402 for placement, or another part of a website or other channel system of which advertising platform 402 is a part. Advertisement platform 402 in embodiments may act as an intermediary between advertisers 430 and one or more external channels, controlling some or all ads displayed over the channels.

System 400 is only one example of a suitable computing environment and is not intended to suggest any limitation as to the scope of use or functionality of the features described herein. The advertising platform 402 is configured to provide interactive advertising and execute one or more computer program modules. In implementations, online community platform 402 may be configured to receive user requests to display advertisements to users. The computer program modules may include one or more of a receiving module 408, a communication module 410, a voting module 412, a trigger module 414, a winner selection module 416, an offer module 418, a grouping module 420, and/or an incentive module 422. As noted, the client computing platform(s) 406 may include one or more computer program modules that are the same as or similar to the computer program modules of the advertising platform(s) 402 to facilitate providing the interactive advertising to the user.

Receiving module 408 may be configured to receive advertisements from advertisers, the advertisements including offers to be extended to consumers. Communication module 410 may be configured to transmit the advertisements, the advertisements being configured to be presented to the consumers. The communication module may be configured to transmit the advertisements in groups. The communication module may be configured to transmit one or more of the groups of advertisements accompanying content pertaining to the subject matter of the groups and/or being of interest to the target demographic of the groups and/or demographic interested in the groups. The communication module may be configured to receive information about the consumers, and the received information may include demographic information, behavioral information and/or location information. Voting module 412 may be configured to receive votes associated with the advertisements during a voting period and to determine numbers of votes received for the advertisements during the voting period. Trigger module 414 may be configured to trigger an end of the voting period. Winner selection module 416 may be configured to determine a winning advertisement, and may be configured to determine one or more winner for each of a number of groups of advertisements. The winner selection module may be configured to determine multiple winning advertisements, one or more of the winning advertisements being demographic winners chosen on the basis of receiving the most votes from consumers sharing certain demographic information. The selected subset of each of the demographic winners may correspond to the demographic information of the consumers from which the demographic winner received the most votes. Offer module 418 may be configured to extend the offer included with the winning advertisement to a selected subset of the consumers. Offer module 418 may be configured to extend offers not associated with a vote-winning advertisement. Grouping module 420 may be configured to group the received advertisements according to at least one of subject matter, target demographic, and interested demographic. Incentive module 422 may be configured to provide at least one incentive to an advertiser associated with the winning advertisement.

In some implementations, the advertising platform 402, client computing platforms 406 and/or advertisement provider(s) 430 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which servers 402, advertisement providers 430, and/or client computing platforms 406 may be operatively linked via some other communication media.

A given client computing platform 406 may include one or more processors configured to execute computer program modules. The computer program modules may be configured to enable an expert or user associated with the given client computing platform 406 to interface with system 400, and/or provide other functionality attributed herein to client computing platforms 406. By way of non-limiting example, the given client computing platform 406 may include one or more of a desktop computer, a laptop computer, a handheld computer, a tablet computing platform, a NetBook, a Smartphone, a gaming console, and/or other computing platforms.

Advertising platform 402 may include electronic storage 404, one or more processors 426, and/or other components. Advertising platform 402 may include communication lines, or ports to enable the exchange of information with a network and/or other computing platforms. Illustration of advertising platform 402 in FIG. 4 is not intended to be limiting. Advertising platform 402 may include a plurality of hardware, software, and/or firmware components operating together to provide the functionality attributed herein to advertising platform 402. For example, advertising platform 402 may be implemented by a cloud of computing platforms operating together as advertising platform 402.

Electronic storage 404 may comprise non-transitory storage media that electronically stores information. The electronic storage media of electronic storage 404 may include one or both of system storage that is provided integrally (i.e., substantially non-removable) with advertising platform 402 and/or removable storage that is removably connectable to advertising platform 402 via, for example, a port (e.g., a USB port, a firewire port, etc.) or a drive (e.g., a disk drive, etc.). Electronic storage 404 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 404 may include one or more virtual storage resources (e.g., cloud storage, a virtual private network, and/or other virtual storage resources). Electronic storage 404 may store software algorithms, information determined by processor 426, information received from advertising platform 402, information received from client computing platforms 406 and/or advertisement provider(s) 430, and/or other information that enables advertising platform 402 to function as described herein.

Processor(s) 426 is configured to provide information processing capabilities in advertising platform 402. As such, processor 426 may include one or more of a digital processor, an analog processor, a digital circuit designed to process information, an analog circuit designed to process information, a state machine, and/or other mechanisms for electronically processing information. Although processor 426 is shown in FIG. 4 as a single entity, this is for illustrative purposes only. In some implementations, processor 426 may include a plurality of processing units. These processing units may be physically located within the same device, or processor 426 may represent processing functionality of a plurality of devices operating in coordination. The processor 426 may be configured to execute modules 408, 410, 412, 414, 416, 418, 420, and 422. Processor 426 may be configured to execute modules 408, 410, 412, 414, 416, 418, 420, and 422 by software; hardware; firmware; some combination of software, hardware, and/or firmware; and/or other mechanisms for configuring processing capabilities on processor 426. As used herein, the term “module” may refer to any component or set of components that perform the functionality attributed to the module. This may include one or more physical processors during execution of processor readable instructions, the processor readable instructions, circuitry, hardware, storage media, or any other components.

In example embodiments, multiple slots to advertise on a given channel are auctioned off. As a condition of their bids, advertisers must provide an offer (discount, freebie, exclusive, etc) to the consumers frequenting that channel. The offers are presented in connection with the advertisements and consumers vote on the ads based on the associated offers. The winning ad's offer is the prize that consumers receive. Winning advertisers receive advertising credits from the website hosting the channel to further incentivize good offers. Good offers highly incentivize consumers to interact with and consume the ads. Such ads are consistent with democratic and meritocratic beliefs held by many, and may enable the monetization of website and other channels without negative repercussions in terms of users feeling exploited or that a channel has become commercialized.

In one example, Yahoo! Inc., Nike, Inc., The Coca-Cola Company, Oracle Corp., and The McDonald's Corp. are the five highest bidders to advertise on a website at a price of $1,000 each. As a part of their bids, Yahoo! Inc. offers free premium fantasy baseball for a year, Nike, Inc. offers a VIP pass to purchase their next limited-release shoe, The McDonald's Corp. offers a coupon for free nuggets, and Oracle Corp. offers a chance to win a ride on their America's Cup boat. Consumers vote and after one week the end of voting is triggered and Nike, Inc.'s offer wins with the most votes. Consumers receive their Nike, Inc. pass prize via an email sent to them by the website. The website collects $5000 ($1000 from each advertiser). All advertisers benefit from having a targeted audience actively participating and engaging with their advertisement (rather than being ignored). Nike, Inc. wins $1000 in website (advertising server) advertising credits to be used in future auctions.

In the foregoing specification, embodiments have been described with reference to specific embodiments. However, one of ordinary skill in the art appreciates that various modifications and changes can be made without departing from the scope of the invention. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Any suitable programming language can be used to implement the routines, methods or programs of embodiments of the invention described herein, including C, C++, Java, Python, assembly language, etc. Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example, only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code).

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

Furthermore, the term “or” as used herein is generally intended to mean “and/or” unless otherwise indicated. As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein, the meaning of “in” includes “in” and “on” unless the context clearly dictates otherwise.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What I claim is:

1. A computer-implemented method of interactive advertising, the method being implemented in a computer network that includes one or more processors executing one or more modules, the method comprising
receiving advertisements from advertisers, the advertisements including offers to be extended to consumers;
transmitting the advertisements, the advertisements being configured to be presented to the consumers;
receiving one or more votes associated with one or more of the advertisements from the consumers during a voting period;
triggering an end of the voting period;
determining numbers of votes received for the advertisements during the voting period;
determining a winning advertisement; and
extending the offer included with the winning advertisement to a selected subset of the consumers.

2. The method of claim 1, further comprising grouping the received advertisements according to at least one of subject matter, target demographic, and interested demographic, and transmitting the advertisements in groups.

3. The method of claim 2, wherein one or more winner is determined for each group.

4. The method of claim 2, wherein one or more of the groups of advertisements are transmitted accompanying content pertaining to the subject matter of the groups or being of interest to the target demographic of the groups or demographic interested in the groups.

5. The method of claim 1, further comprising receiving location information about the consumers, wherein the advertisements are transmitted to consumers based on the received location information.

6. The method of claim 5, wherein the advertisements relate to products and/or services near the consumers, and wherein the consumers immediately receive the offers included in the advertisements they vote for.

7. The method of claim 1, wherein the triggering is associated with a defined time period elapsing, an advertisement threshold associated with the number of votes received by the advertisement being crossed, or a vote threshold associated with a total number of votes received being crossed.

8. The method of claim 1, further comprising:
receiving information about the consumers, wherein the information comprises demographic information or behavioral information.

9. The method of claim 8, wherein the selected subset is associated with at least one of the demographic information and the behavioral information.

10. The method of claim 8, further comprising determining multiple winning advertisements, one or more of the winning advertisements being demographic winners chosen on the basis of receiving the most votes from consumers sharing certain demographic information.

11. The method of claim 10, wherein the selected subset of each of the demographic winners corresponds to the demographic information of the consumers from which the demographic winner received the most votes.

12. The method of claim 1, wherein the selected subset comprises consumers who voted for the advertisement.

13. The method of claim 1, wherein an advertiser associated with the winning advertisement receives at least one incentive from a channel that presented the winning advertisement to the consumers.

14. The method of claim 1, wherein the triggering is associated with votes cast reaching a threshold percentage of total possible votes or a threshold percentage of a portion of total possible votes representing a number of votes reasonably likely to be cast.

15. An interactive advertising system, the system comprising:
one or more computing devices configured to execute modules, the modules comprising:
a receiving module configured to receive advertisements from advertisers, the advertisements including offers to be extended to consumers;
a communication module configured to transmit the advertisements, the advertisements being configured to be presented to the consumers;
a voting module configured to receive votes associated with the advertisements during a voting period and to determine numbers of votes received for the advertisements during the voting period;
a trigger module configured to trigger an end of the voting period;
a winner selection module configured to determine a winning advertisement; and
an offer module configured to extend the offer included with the winning advertisement to a selected subset of the consumers.

16. The system of claim 15, further comprising a grouping module configured to group the received advertisements according to at least one of subject matter, target demographic, and interested demographic, and wherein the communication module is configured to transmit the advertisements in groups.

17. The system of claim 16, wherein the winner selection module is configured to determine one or more winner for each group.

18. The system of claim 16, wherein the communication module is configured to transmit one or more of the groups of advertisements accompanying content pertaining to the subject matter of the groups or being of interest to the target demographic of the groups or demographic interested in the groups.

19. The system of claim 15, wherein the communication module is further configured to receive information about the consumers, wherein the information comprises demographic information or behavioral information.

20. The system of claim 19, wherein the winner selection module is configured to determine multiple winning advertisements, one or more of the winning advertisements being demographic winners chosen on the basis of receiving the most votes from consumers sharing certain demographic information.

21. The system of claim 20, wherein the selected subset of each of the demographic winners corresponds to the demographic information of the consumers from which the demographic winner received the most votes.

22. The system of claim 15, further comprising an incentive module configured to provide at least one incentive to an advertiser associated with the winning advertisement.
